(19) United States
(12) Patent Application Publication
(10) Pub. No.: US 2011/0226104 A1
(43) Pub. Date: Sep. 22, 2011

(54) Tool guide

(76) Inventor: Allan Charles Chase, West Kelowna (CA)

(21) Appl. No.: 13/064,258

(22) Filed: Mar. 15, 2011

Related U.S. Application Data
(60) Provisional application No. 61/340,706, filed on Mar. 22, 2010.

(51) Int. Cl. B26D 7/00; B23D 59/00

(52) U.S. Cl. 83/56; 83/745

(57) ABSTRACT

A method and apparatus for guiding a cutting tool. The apparatus comprises at least one elongate member having a first track extending longitudinally therealong and a first clamping member located at a first end of a first elongate member and extending perpendicularly thereto. The apparatus further includes a second clamping member slidably locatable along the first track. The second clamping member is adjustably securable within the first track so as to clamp a work piece between the first and second clamping member. The method comprises longitudinally connecting the first and second elongate members with a connection member, applying the first and second elongate members to a surface of the material and clamping the elongate member to the material at a position corresponding to a line to be cut in the material between the first clamping member and the second clamping member.

### CROSS REFERENCE TO RELATED APPLICATION

This application claims the benefit of priority from U.S. Provisional Patent Application No. 61/340,706 filed Mar. 22, 2010 entitled Exacta-guide.

### BACKGROUND OF THE INVENTION

1. Field of Invention The present invention relates to tools in general and in particular to a method and apparatus for guiding one of a plurality of tools along a work surface.

2. Description of Related Art

In the fields of woodworking and construction, hand and portable power tools are frequently employed to cut, rout or otherwise machine a portion of the wood. Such tools are frequently required to perform such task in a straight line across or along the work piece so as to ensure a straight edge or consistent finish.

With the use of hand or portable power tools, a guide is frequently employed to provide a straight line across the work piece for the tool to follow so as to ensure a straight cut. Such guides have previously been insufficient for use in a wide variety of cutting tools and a wide variety of cutting situations.

Some guides have been adapted to cut across wide work pieces and have therefore included a long guide member which may be connected at various locations along the guide member. Such guides are cumbersome for use with smaller work pieces due to the excess length extending therefrom. Many of these types of guides include threaded fastening means which clamp the work piece between a threaded member and a base surface due to the need to apply a solid connection to the work piece. Such fastening means are known to be time consuming to apply. One example of such a prior guide may be found in U.S. Pat. No. 7,063,000 to Molburg.

Other guides are designed to have stricter limits placed upon the lengths of the cut that they may guide which has limited their use on wider work pieces. Such guides have included a captured clamping member having a limited motion of travel to provide the above limit on the cut length. Such a limit to the work piece size however either requires that the device be limited to small cut lengths so as to be of a manageable size for small jobs or to have a length so long that they would become awkward for when used with smaller work pieces than for which they were designed. Thus many such guides are a compromise of the usefulness for their intended size range verses the range of cuts for which they may be used. Many of these type of devices also have clamping mechanisms are to be adjusted to a desired position on either side of the work piece and then tightened against the guide member which do not provide a satisfactory clamping force. An example of such guides may be found at U.S. Pat. No. 3,913,440 to Baker.

### SUMMARY OF THE INVENTION

According to a first embodiment of the present invention there is disclosed an apparatus for guiding a cutting tool. The apparatus comprises at least one elongate member having a first track extending longitudinally therealong a first clamping member located at a first end of a first elongate member and extending perpendicularly thereto. The first clamping member is operable to have an indicator corresponding to a cutting line of the cutting tool cut therein by the cutting tool. The apparatus further includes a second clamping member slidably locatable along the first track. The second clamping member is adjustably securable within the first track so as to clamp a work piece between the first and second clamping member.

The at least one elongate member may comprise a plurality of elongate members longitudinally connected to each other. The plurality of elongate members may be connectable to each other with a connector member. The plurality of elongate members may further include a second track extending longitudinally therealong. The second track may comprise a second pair of interior opposed grooves located within the elongate member. The connector member may comprise a plate securable within the second track.

The first track may comprise a first pair of interior opposed grooves located within the elongate member. The second clamping member may include a slide portion slidably received between the first pair of opposed grooves. The slide portion may comprise a plate connectable to a body portion of the second clamping member with a fastener wherein the body portion and the plate may grip a flange of the elongate member therebetween by tightening the fastener. The body portion may be formed of a material selected from the group consisting of rubber, plastic, wood or silicon. The body portion may include an inclined clamping surface adapted to wedge the work piece between the first and second clamping bodies as the apparatus is pressed downwardly on the work piece.

The first clamping member may comprise a bar perpendicularly secured to the first elongate member. The first clamping member may be formed of a material selected from the group consisting of wood or plastic. The apparatus may further include a pair of parallel spaced apart of longitudinal alignment passages sized to receive a pair of alignment rods therein for aligning the plurality of elongate members.

The alignment passages may be located between the first and second tracks. The apparatus may further comprise a guide arm rotatably connected to the first end of the first elongate member.

According to a further embodiment of the present invention there is disclosed a method for sawing a material. The method comprises providing a first elongate member extending between first and second ends, inserting a connection member within the second end of the first elongate member and receiving the connection member within a first end of a second elongate member to form a continuous guide edge with the first and second elongate members. The method further comprises applying the first and second elongate members to a surface of the material and clamping the elongate member to the material at a position corresponding to a line to be cut in the material between a first clamping member located at a first end of the first member and a second clamping member slidably and selectably fixably locatable within a first track of the first and second elongate members.

The method may comprise locating the first clamping member adjacent to a first edge of the work piece, locating a inclined clamping surface of the second clamping member adjacent to a second edge of the work piece and pressing the second clamping member onto the work piece so as to wedge the work piece between the first and second clamping bodies.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a guide apparatus according to a first embodiment of the present invention having an angular guide member extended therefrom.

FIG. 2 is a perspective view of the guide apparatus of FIG. 1 with a guide extension applied thereto.

FIG. 3 is a cross sectional view of the guide apparatus of FIG. 1 as taken along the line 3-3 from FIG. 2.

FIG. 4 is a cross sectional view of the guide apparatus of FIG. 1 as taken along the line 4-4 from FIG. 2.

FIG. 5 is an exploded perspective view of the clamping member of the guide apparatus of FIG. 1.

FIG. 6 is a cross sectional view of the clamping member of FIG. 5 as taken along the line 5-5.

FIG. 7 is a side view of the apparatus of FIG. 1 being applied to a work piece in a first position.

FIG. 8 is a side view of the apparatus of FIG. 1 being applied to a work piece in a second position.

### DETAILED DESCRIPTION

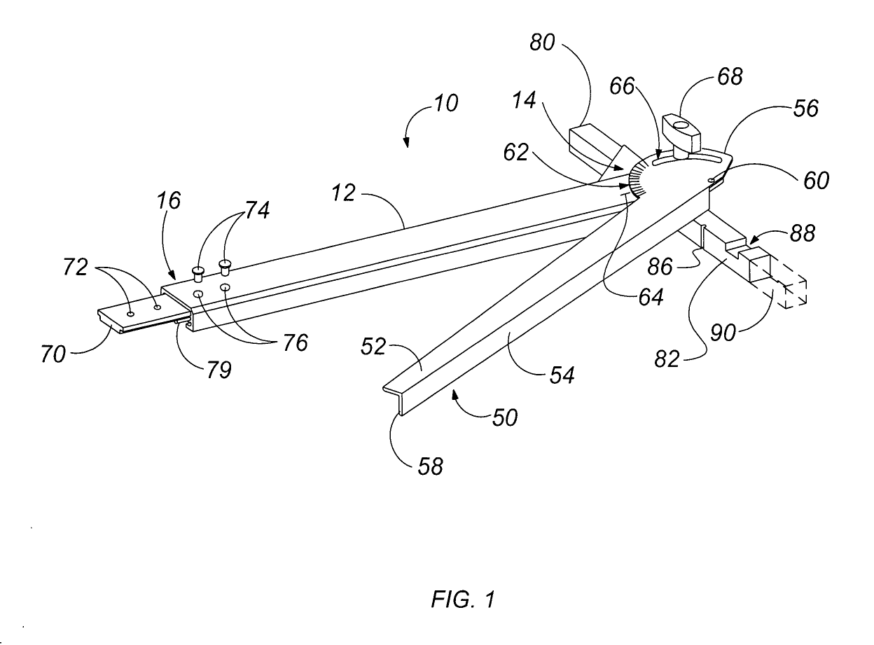

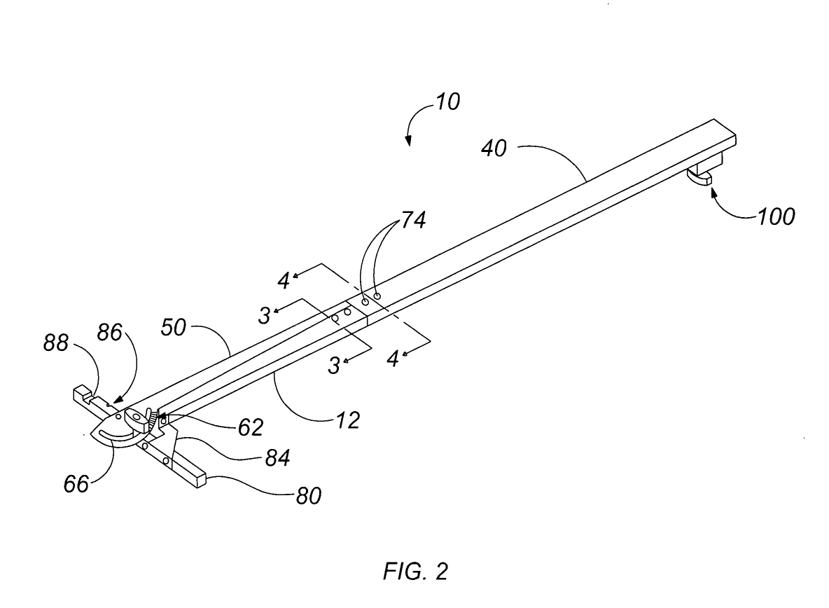

Referring to FIGS. 1 and 2, an apparatus for guiding the path of a cutting tool according to a first embodiment of the invention is shown generally at 10. The apparatus 10 comprises a first elongate member 12 extending between first and second ends, 14 and 16, respectively, and first and second clamping members, 80 and 100, respectively, for securing the elongate member to a work piece as will be more fully described below. The apparatus also includes an angular guide member or arm 50 pivotally attached to the first end 14 of the first elongate member 12. The apparatus may also have additional elongate members 40 longitudinally secured to the second end 16 of the elongate member 12 as illustrated in FIG. 2 so as to extend the length of the apparatus for use in cutting wider work pieces. Although only a single second elongate member 40 is illustrated connected to the first elongate member 12 in FIG. 2, it will be appreciated that more than one additional elongate member may be secured thereto as needed. In such applications, a connector member 70 as illustrated in FIG. 1 may be utilized to connect the elongate members together. The first elongate member 12 may have a length selected to permit use in cutting a range of work pieces up to a conventional rage of dimension lumber, such as by selecting first elongate member 12 having length of between 12 and 20 inches (305 to 508 mm) by way of non limiting example. Similarly, additional elongate members 40 may thereafter be provided to permit the apparatus 10 to guide tools across work pieces of increased size. By way of non-limiting example, such additional elongate members 40 may have lengths of 33 inches (838 mm) although it will be appreciated that other lengths will be useful as well.

The guide arm 50 comprises an elongate angular channel formed by horizontal and vertical planar sections, 52 and 54, respectively extending between first and second ends, 56 and 58 respectively. The first end 56 is pivotally connected to the first end 14 of the elongate member 12 about a pin 60 and includes a plurality of angular indicators on a top surface thereof, generally indicated at 62. Any one of the angular indicators may be selectably aligned with a reference indicator 64 located on the elongate member 12 to indicate the angle defined therebetween. When not in use to provide a non-parallel guide path from the elongate member, the guide arm may be located proximate thereto as illustrated in FIG. 2. The first end 56 of the guide arm 50 may also include an arcuate slot 66 extending there through having a radius about the pin 60 and a threaded post extending therethrough (not shown) and hand knob or wing nut 68 as are commonly known in the art located thereon so as to tighten the guide arm 50 against the elongate member 12 so as to fix the angular orientation thereof.

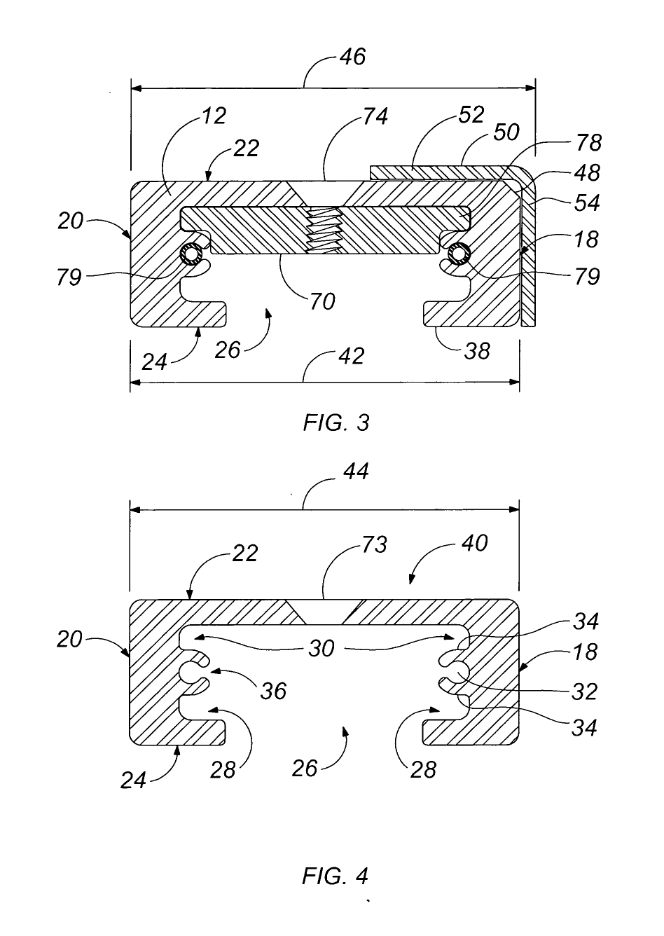

Turning now to FIGS. 3 and 4, cross sectional views of the elongate members 12 and 40 are illustrated along the lines 3-3 and 4-4 of FIG. 2, respectively. The elongate member 12 comprises an elongate body having first and second side edges, 18 and 20, respectively, and top and bottom sides, 22 and 24, respectively. The bottom side 24 includes an interior cavity 26 therein having a first and second grooves or channels, 28 and 30, respectively, for receiving the second clamping member and a connector member therein as well as a pair of passages 32 for receiving a pair of longitudinal alignment rods therein. The first set of opposed grooves 28 form a first track therebetween. As illustrated in FIG. 3, the first grooves 28 may receive the connector member 70 therein. The second set of opposed grooves 30 form a second track therebetween and are operable to receive a portion of the second clamping member therein as will be further described below. The passages 32 are sized to receive elongate alignment rods 80 or pins therein as illustrated in FIGS. 1 and 3. The alignment rods 80 may be selected to have a size corresponding to the passages 32 for a close fit therein and to have any length sufficient to assist in the alignment of the first and second elongate members. The passages 32 are defined by a pair of arcuately curved walls 34 extending from the first and second sides 18 and 20 of the elongate member and having a gap 36 between the distal ends thereof. As illustrated in FIG. 4, the first track may be located proximate to the bottom side 24 of the elongate member 12 wherein the second track is located proximate to the top side 22 of the elongate member with the passages 32 therebetween. In such an arrangement, the first grooves 28 forming the first track are defined between the bottommost curved walls 34 of the passages 32 and a bottom flange 38 of the elongate member. Similarly, the second grooves 30 forming the second track are defined between the topmost curved walls 34 and the top side 22 of the elongate member 12.

It will be appreciated that the first and second elongate members 12 and 40 have similar cross sectional profiles so as to facilitate the longitudinal movement of the second clamping member 100 therealong. However as illustrated in FIG. 3, it will be observed that the first elongate member 12 has a width 42 selected to be less than the width 44 of the additional elongate members 40 so that when the guide arm 50 is located proximate thereto, the guide arm 50 and first edge 18 of the second elongate member will provide a continuous guide surface. In particular, it will be observed that the width difference between the first and second elongate members 12 and 40 may be accomplished by reducing the thickness of the wall forming the first side edge 18 of the first elongate member 12 by an amount corresponding to the thickness of the vertical section 54 of the guide arm 50. Accordingly the width of the first elongate member 12 and guide arm 50 combined, indicated at 46, will be equal to the width 44 of the second elongate member 40 alone. As illustrated in FIG. 3, the first elongate member 12 may also include a chamfered corner 48 so as to facilitate the guide arm 50 being rotated into close proximity thereto.

It will be appreciated that an elongate member according to the above description may be formed of any suitable material by any suitable methods. In particular, the elongate member may be formed of a metal, such as, by way of non-limiting example, aluminium, steel, stainless steel, copper or alloys thereof, plastics, ceramics or wood. The elongate member may also be formed of any suitable methods, such as, by way of non-limiting example machining, extrusion, bending, casting or roll forming.

The second elongate member 40 may be connected to the first elongate member by inserting a connector member 70 into the second grooves 30 as illustrated in FIGS. 1 and 3. The connector member 70 comprises a plate sized to be received within the first grooves 30 having bores 72 therein sized to receive fasteners 74, such as, by way of non-limiting example screws, bolts, pins or rivets therein. The first and second elongate members 12 and 40 also include corresponding bores 73 sized to pass the fasteners therethrough. Optionally the connector member 70 may be sized to be thicker than the first grooves 30 and include a shoulder 78

The first clamping member 80 comprises a bar fixedly located proximate to the bottom of the first end 14 of the first elongate member having a clamping surface 82 disposed towards the second end 16 of the elongate member. The first clamping member 80 is oriented perpendicularly to the first elongate member 12 so as to provide a guide path that is normal to the edge of a work piece when the apparatus 10 is secured thereto. The first clamping member 80 may be secured to the first elongate member 12 by a bracket 84 and fasteners as illustrated in FIGS. 1 and 2. The first clamping member 80 may be formed of a material selected to permit machining by the cutting tool of the user. In particular, the first clamping member may be formed of any suitable machineable material, such as, by way of non-limiting example, wood or plastic. In operation a user may customize the first clamping member 80 of their apparatus to provide one or more measurement indicators corresponding to the cutting location of their tools. By way of non-limiting example, a user may make a first cut with a sabre saw slightly into the first clamping member 80 so as to provide a front notch 86. The user may also make a first cut with a circular saw so as to remove a portion of the end of the first clamping member 80, generally indicated at 90 or may make a first pass with a router to make a top notch 88. The first front and top notches 86 and 88 and end of the first clamping member 80 may thereafter be utilized to guide the user as to the proper location of the apparatus to make their desired cut. It will be appreciated that the first clamping member 80 may also have a thickness sufficient to permit the router to be passed through without excessively weakening the first clamping member 80. In particular, it has been found that a thickness of at least ½ inch (13 mm) has been suitable with a thickness of more than ¾ inch (19 mm) being particularly useful.

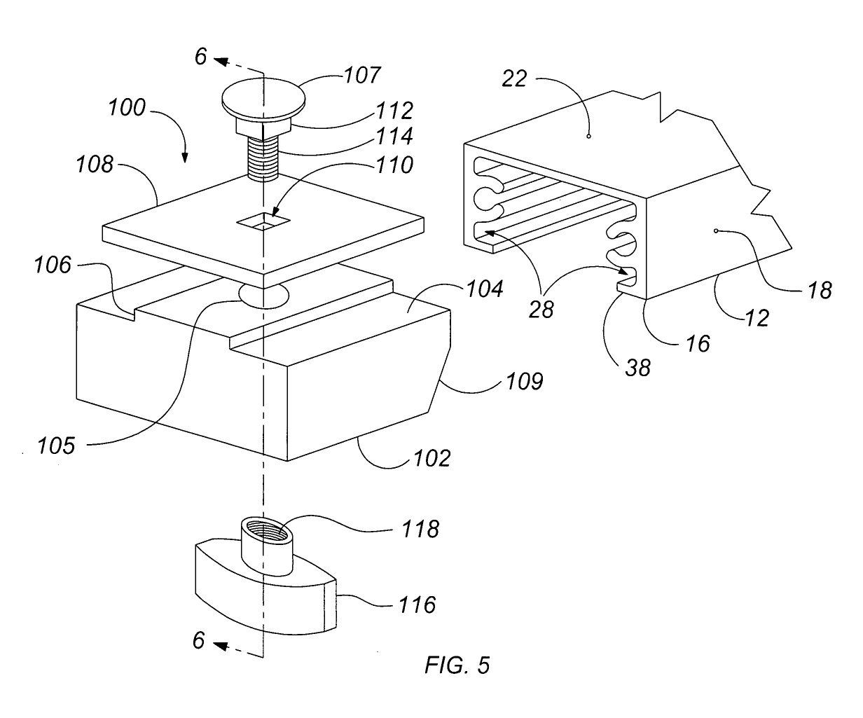

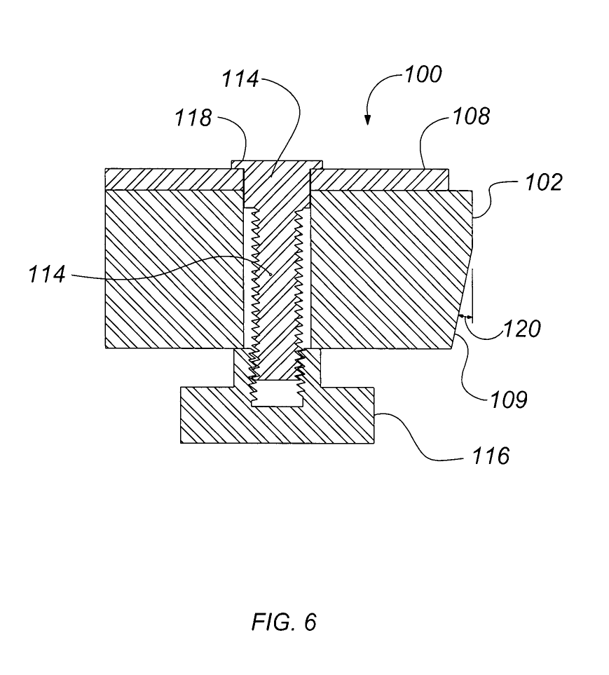

Turning now to FIGS. 5 and 6, the second clamping member 100 comprises a clamping body 102 connectable to a plate 108 by a threaded fastener 107, such as a carriage bolt. The clamping body 102 includes a bore 105 therethrough and a top shoulder 104 proximate to either side with a narrowed region 106 therebetween. The narrowed region 106 is sized to pass between the bottom flanges 38 of the first or second elongate members 12 or 40. The clamping body 102 also includes an angularly oriented lead clamping surface 106 at a leading edge thereof. The clamping surface 109 may have an angle, generally indicated at 120 of between 0 and 60 degrees. The plate 108 is sized to be slidably received within the first grooves 28 of the first or second elongate ember 12 or 40 and includes square a bore 110 therethrough to receive a corresponding square portion 112 of the fastener 107. The fastener 107 includes a threaded post 114 which is sized to be passed through the bore 105 of the clamping body 102 and threadably received within a threaded receptacle 118, of a handle or knob 116. In operation the plate 108 may be located within the first grooves 28 such that the bottom flange 38 of the first or second elongate member 12 or 40 is between the plate 108 and the shoulder 104 of the clamping body. Thereafter the fastener 112 may be tightened into the nut 118 so as to compressible grip the bottom flange 38 therebetween at a position as desired by the user.

The clamping body 102 may be formed of a resilient material such as, by way of non-limiting example, natural or synthetic rubbers, plastics, silicon, wood, or composite materials. In particular the clamping body may be formed of a material having sufficient hardness to firmly grip the work piece while permitting a sufficient amount of flexibility to enable application thereto as described above. It has been found that rubbers having a Shore A hardness from about 80 to 100 has been useful.

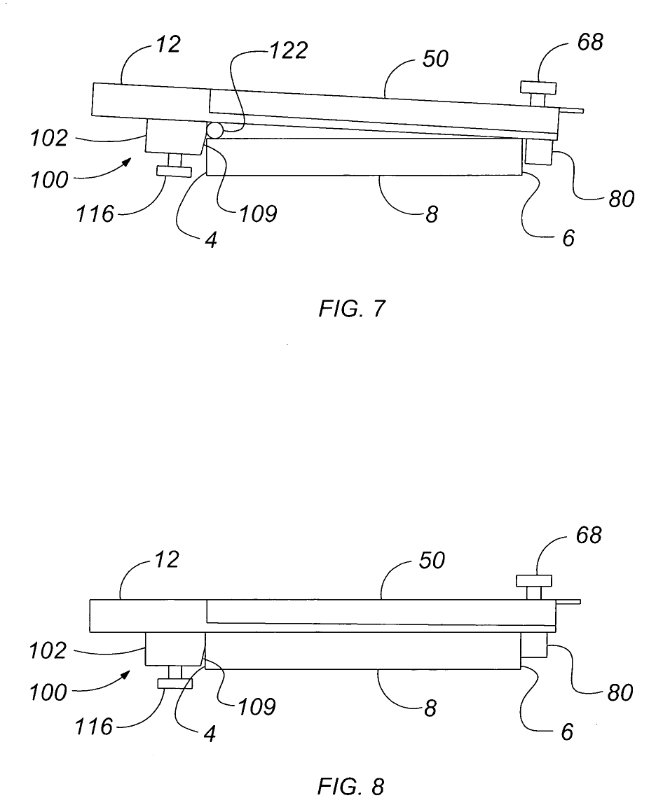

With reference to FIGS. 7 and 8, the apparatus 10 may be applied to a work piece 8 by placing the apparatus on top of the work piece and locating the first clamping member 100 proximate to a first edge 6 of the work piece. The second clamping member may then be slidably located along the first elongate member 12 to be proximate to the second edge 4 of the work piece. Optionally, a pencil 122 or other small object may be placed under the first elongate member 12 proximate to the second clamping body 100 so as to space the first elongate member 12 away from the work piece at that location as illustrated in FIG. 7. This additional spacing will permit the second clamping member 100 to be located closer to the first clamping member 80. After the second clamping member 100 has been secured to this closer position, the pencil 122 may be removed and the elongate member pressed downwardly onto the work piece such that the clamping body 102 is biasedly deformed as the clamping surface 109 is slidably passed over the second edge 4 of the work piece 8. It will be appreciated that the angular orientation of the clamping surface 109 assists with guiding the second clamping member 100 over the second edge 4 of the work piece while the compressible material of the second clamping body 102 serves to compressibly grip the work piece between the first and second clamping bodies thereafter providing a more secure clamping guide.

While specific embodiments of the invention have been described and illustrated, such embodiments should be considered illustrative of the invention only and not as limiting the invention as construed in accordance with the accompanying claims.

What is claimed is:

1. An apparatus for guiding a cutting tool comprising, the apparatus comprising:
at least one elongate member having a first track extending longitudinally therealong;
a first clamping member located at a first end of a first elongate member and extending perpendicularly thereto, said first clamping member operable to have an indicator corresponding to a cutting line of said cutting tool cut therein by said cutting tool; and
a second clamping member slidably locatable along said first track, said second clamping member being selectably securable within said first track so as to clamp a work piece between said first and second clamping member.

2. The apparatus of claim 1 wherein said at least one elongate member comprises a plurality of elongate members longitudinally connected to each other.

3. The apparatus of claim 2 wherein said plurality of elongate members are connectable to each other with a connector member.

4. The apparatus of claim 3 wherein said plurality of elongate members further include a second track extending longitudinally therealong.

5. The apparatus of claim 4 wherein said second track comprises a second pair of interior opposed grooves located within said elongate member.

6. The apparatus of claim 4 wherein said connector member comprises a plate securable within said second track.

7. The apparatus of claim 1 wherein said first track comprises a first pair of interior opposed grooves located within said elongate member.

8. The apparatus of claim 7 wherein said second clamping member includes a slide portion slidably received between said first pair of opposed grooves.

9. The apparatus of claim 1 wherein said slide portion comprises a plate connectable to a body portion of said second connector with a fastener wherein said body portion and said plate grip a flange of said elongate member therebetween by tightening said fastener.

10. The apparatus of claim 9 wherein said body portion is formed of a material selected from the group consisting of rubber, plastic, wood or silicon.

11. The apparatus of claim 10 wherein said body portion includes an inclined clamping surface adapted to wedge said work piece between said first and second clamping bodies as said apparatus is pressed downwardly on said work piece.

12. The apparatus of claim 1 wherein said first clamping member comprises a bar perpendicularly secured to said first elongate member.

13. The apparatus of claim 12 wherein said first clamping member is formed of a material selected from the group consisting of wood or plastic.

14. The apparatus of claim 4 further including a pair of parallel spaced apart of longitudinal alignment passages sized to receive a pair of alignment rods therein for aligning said plurality of elongate members.

15. The apparatus of claim 14 wherein said alignment passages is located between said first and second tracks.

16. The apparatus of claim 1 further comprising a guide arm rotatably connected to said first end of said first elongate member.

17. A method for sawing a material, the method comprising:
providing a first elongate member extending between first and second ends;
inserting a connection member within said second end of said first elongate member;
receiving said connection member within a first end of a second elongate member to form a continuous guide edge with said first and second elongate members;
applying said first and second elongate members to a surface of said material; and
clamping said elongate member to said material at a position corresponding to a line to be cut in said material between a first clamping member located at a first end of said first member and a second clamping member slidably and selectably fixably locatable within a first track of said first and second elongate members.

18. The method of claim 17 wherein said applying comprises locating said first clamping member adjacent to a first edge of the work piece, locating a inclined clamping surface of said second clamping member adjacent to a second edge of the work piece and pressing said second clamping member onto the work piece so as to wedge said work piece between said first and second clamping bodies.
